(19) United States
(12) Patent Application Publication
(10) Pub. No.: US 2001/0044024 A1
(43) Pub. Date: Nov. 22, 2001

(54) Acrylic hot melt pressure-sensitive adhesive and protective film utilizing the same

(76) Inventors: Hiraku Miyashita, Osaka (JP); Masateru Fukuoka, Osaka (JP); Hajime Nosetani, Hasuda-shi (JP); Hidemi Matsunaga, Hasuda-shi (JP); Masatoshi Yoshida, Nara-shi (JP); Nobuhiro Kobayashi, Osaka (JP); Koji Kahara, Osaka (JP)

Correspondence Address: LAW OFFICES OF TOWNSEND & BANTA, P.C., Suite 500, 1225 Eye Street, N.W., Washington, DC, 20005, US

(21) Appl. No.: 09/824,817

(22) Filed: Apr. 4, 2001

(30) Foreign Application Priority Data
Apr. 6, 2000 (JP) 105159/2000

(51) Int. Cl. B32B 15/04

(52) U.S. Cl. 428/355 R; 428/343

(57) ABSTRACT

An acrylic hot melt pressure-sensitive adhesive, for use in a protective film, is disclosed which can be produced by free-radical polymerization, which exhibits the improved low temperature tackiness and weather resistance, and which shows good peel adhesion to adherends regardless of their types.

The acrylic hot melt pressure-sensitive adhesive contains a block copolymer comprising a polyvalent mercaptan core, first and second acrylic polymer segments different in composition from each other and radially extending from the mercaptan core. Both or one of the first and second polymer segments is copolymerized with an olefinic macromonomer.

### BACKGROUND OF THE INVENTION

1. Field of the Invention

The present invention relates to an acrylic hot melt pressure-sensitive adhesive and a protective film including such adhesive for use in protecting various instruments, products and the like. More particularly, the present invention relates to an acrylic hot melt pressure-sensitive adhesive which exhibits improved low temperature tackiness and weather resistance and shows good peel adhesion to an adherend, regardless of its type, and also to a protective film having a layer of such an adhesive.

2. Description of Related Art

As the recent demand for high-performance or high-function polymeric compounds increases, homopolymers and random copolymers become more difficult to meet such demand. This has led us to recognize the importance of graft and block copolymers containing different polymeric entities.

For the purposes of protecting various products and instruments, protective films have been conventionally used incorporating a pressure-sensitive adhesive layer provided on a substrate. Examples of pressure-sensitive adhesives useful for incorporation in such protective films include those prepared via addition of tackifying polymers to thermoplastic polymers such as ethylene-vinyl acetate copolymer (EVA), styrene-ethylene-butylene-styrene copolymer (SEBS) and the like; and those prepared via addition of tackifying polymers to acrylic random copolymers.

However, the EVA- or SEBS-based pressure-sensitive adhesives show insufficient weather resistance and a marked variation in peel adhesion depending upon the type of the adherend used. On the other hand, the acrylic random copolymer-based pressure-sensitive adhesives, while showing good weather resistance, have been difficult to optimize a balance of low temperature tackiness and a cohesive force. For example, the attempt to insure an adequate cohesive force by increasing a glass transition temperature Tg of the acrylic random copolymer results in the reduced low temperature tackiness, which has been a problem.

Japanese Kohyo Patent No. Hei 9-502467 (1997) discloses an acrylic pressure-sensitive graft polymer produced via copolymerization of an acrylic base polymer with an olefinic macromer. This copolymerization with the olefinic macromer is reported to improve high-temperature shear properties and weather resistance of the graft polymer and enhance its adherence to a surface of a nonpolar adherend. However, this acrylic pressure-sensitive graft polymer is produced using a crosslinking agent and accordingly exhibits a cohesive force insufficient for use as a protective film.

In order to achieve the simultaneous optimization of cohesive force and low temperature tackiness, acrylic block copolymers may be used containing distinct blocks which individually function to either improve a cohesive force or enhance low temperature tackiness. Conventionally, such block copolymers are produced by anionic polymerization. However, the anionic polymerization presents the following problems: it puts restrictions on the types of applicable monomers; it is more complex in mechanism than free-radical polymerization; and it is costly. Another disadvantage is that, due to their highly polar characters, conventional acrylic copolymers tend to show the increased peel adhesion to high-polarity adherends such as metals but the reduced peel adhesion to low-polarity adherends such as olefinic resin sheets.

### SUMMARY OF THE INVENTION

It is an object of the present invention to provide an acrylic hot melt pressure-sensitive adhesive which exhibits improved low temperature tackiness and weather resistance and shows consistent peel adhesion to adherends, regardless of their polar characters, and also to provide a protective film utilizing such a hot melt pressure-sensitive adhesive.

The present invention is directed toward solving the above-described problems. The acrylic hot melt pressure-sensitive adhesive in accordance with the present invention is characterized as containing a block copolymer comprising a polyvalent mercaptan core, first and second acrylic polymer segments which have different compositions and extend radially from the polyvalent mercaptan core, and an olefinic macromonomer which forms a copolymer with both or one of the first and second polymer segments. In the present invention, the first and second acrylic polymer segments emanating from the polyvalent mercaptan core differ in composition from each other. This difference makes them responsible for different functions and reduces the variation in peel adhesion of the resulting acrylic hot melt pressure-sensitive adhesive depending on the polarity of the adherend used, as contrary to conventional acrylic pressure-sensitive adhesives produced via random copolymerization. Particularly when the first and second polymer segments are distinguished from each other in terms of glass transition temperature Tg, the low temperature tackiness and cohesion force can be better balanced. Further, when they are copolymerized with the olefinic macromer, the peel adhesion of the resulting adhesive to low-polarity adherends such as olefinic resin sheets is rendered comparable to that to high-polarity adherends, so that the variation in peel adhesion of the adhesive dependent on the polarity of the adherend can be effectively reduced. Also, since a crosslinking process is not required to involve in the preparation of the acrylic hot melt pressure-sensitive adhesive in accordance with the present invention, simple hot melt application thereof to a surface of a base film layer results in provision of a surface protection film.

In a particular aspect of the present invention, the acrylic hot melt pressure-sensitive adhesive includes the first polymer segment having a Tg of not below 35° C. and the second polymer segment having a Tg of not above 0° C. In such a design, this pressure-sensitive adhesive can be imparted thereto the enhanced cohesive force by the first polymer segment and the improved tackiness by the second polymer segment and, as a result, shows the highly balanced tackiness-cohesion relationship.

In another particular aspect of the present invention, the olefinic macromer contains an olefinic moiety selected from the group consisting of an ethylene polymer, ethylene-butylene copolymer, ethylene-propylene copolymer and any mixture thereof. In such a case, the peel adhesion can be enhanced relative to low-polarity adherends such as olefinic resin sheets.

The protective film in accordance with the present invention includes the pressure-sensitive adhesive layer in accordance with the present invention and a base film layer carrying the pressure-sensitive adhesive layer on its one side. Characteristically, its initial 180° peel adhesion to a stainless steel sheet does not exceed 4.903325 N/25 mm when measured at 23° C. according to JIS Z 0237. The protective film in accordance with the present invention thus exhibits good removability relative to the stainless steel sheet. Also, the pressure-sensitive adhesive layer is formed from the acrylic hot melt pressure-sensitive adhesive in accordance with the present invention. This permits the protective film to result from easy hot melt application of the acrylic hot melt pressure-sensitive adhesive to the base film layer. Hence, the protective film can be provided inexpensively.

Due to the inclusion of the acrylic hot melt pressure-sensitive adhesive in accordance with the present invention which contains the first and second polymer segments having different compositions and selectively copolymerized with the olefinic macromonomer, the protective film in accordance with the present invention can enjoy the properties of the pressure-sensitive adhesive, i.e., good low temperature tackiness and reduced variation in peel adhesion dependent upon the type of the adherend used.

The base film layer is preferably made of polyethylene or polypropylene. Good adhesive properties of the acrylic hot melt pressure-sensitive adhesive in accordance with the present invention permits the use of polyethylene or polypropylene for the base film layer of the protective film.

The present invention is below described in detail.

The acrylic hot melt pressure-sensitive adhesive in accordance with the present invention includes the aforesaid first and second polymer segments which extend radially from the polyvalent mercaptan core. The orientation of their radial extensions relative to each other is not particularly specified. That is, the first and second polymer segments may extend in two different directions from the central polyvalent mercaptan core in a wide variety of relative orientations.

Both or one of the first and second polymer segments may be present in plurality. Also, a polymer segment other than the first and second polymer segments may be coupled to the polyvalent mercaptan core.

The polyvalent mercaptan core, as used herein, refers to a polyvalent mercaptan residue after protons have been dissociated from plural mercapto groups. The first and second polymer segments are segments that result from polymerization, preferably free-radical polymerization of polymeric monomers. The first and second polymer segments may comprise a homopolymer or copolymer.

The polymer segment when produced via free-radical polymerization can have a composition selected from a wider composition range than when produced via anionic or other ionic polymerization. The type of the monomer used is not particularly specified, so long as it is free-radically polymerizable. The polymer segment produced by free-radical polymerization is readily subjected to copolymerization.

The first and second polymer segments each has a terminal carbon atom coupled to a mercapto-derived sulfur atom.

The polyvalent mercaptan, as described in the present invention, is a compound having two or more mercapto groups per molecule. The mercaptan containing two or three mercapto groups may be referred to as divalent or trivalent mercaptan.

Examples of polyvalent mercaptans include diesters made by esterification of diols, such as ethylene glycol and 1,4-butanediol, with carboxyl-containing mercaptans; polyester compounds made by esterification of compounds having three or more hydroxyl groups with carboxyl-containing mercaptans; compounds having three or more mercapto groups such as trithio glycerol; triazine polythiols such as 2-di-n-butylamino-4,6-dimethylcapto-s-triazine and 2,4,6-trimercapto-s-triazine; compounds having plural mercapto groups introduced by addition of hydrogen sulfide to epoxy groups in polyvalent epoxy compounds; ester compounds made by esterification of carboxyl groups in polycarboxylic acid with mercaptoethanol.

The above-listed polyvalent mercaptans may be used alone or in any combination. The above-described carboxyl-containing mercaptans are compounds which contain a mercapto group and a carboxyl group, as exemplified by thioglycolic acid, mercapto-propionic acid and thiosalicylic acid and the like.

In order to achieve efficient production of the above-described copolymer and to increase its performance by introducing a radial structure consisting of arms emanating from the common center, the aforesaid polyvalent mercaptan preferably contains 2-10 mercapto groups, i.e., di- to decavalent mercaptans, more preferably 3-6 mercapto groups, i.e., tri- to hexavalent mercaptans. It becomes difficult to obtain the radial structure having the first and second polymer segments emanating from the common center, if the mercaptan contains a single mercapto group or more than ten mercapto group.

More specifically, those tri- to hexavalent mercaptans are preferably derived from at least one compound selected from the group consisting of trimethylolprapane trithioglycolate, trimethylolpropane trithiopropionate, pentaerythritol tetrakisthioglycolate, pentaetythritol tetrakisthiopropionate, dipentaerythritol hexakisthioglycolate and dipentaerythritol hexakisthiopropionate. The use of the polyvalent mercaptan core derived from any of those polyvalent mercaptans results in obtaining a block copolymer having a star structure whereby the first and second polymer segments radially extend from the common center. As a result, the increase in cohesive force can be expected from entanglement of polymer chains or from the formation change due to phase separation that may occur in the structure.

In the present invention, the first and second polymer segments extend radially from the polyvalent mercaptan core and differ in composition from each other. Where the first and second polymer segments each consists of a homopolymer, such a compositional difference can be provided by varying the type of -monomeric unit or the number of the monomeric units present in the homopolymer, or the average molecular weight of the homopolymer. The first and second polymer segments have weight-average molecular weights preferably in the range of 10,000-5,000,000, more preferably in the range of 50,000-2,000,000, still more preferably in the range of 100,000-1,000,000. If their weight-average molecular weights are below the specified range, it may become difficult to introduce the purposed block-based properties into the block copolymer. On the other hand, if their weight-average molecular weights exceed the specified range, their viscosity or melt viscosity may be caused to increase excessively during production to result in lowering the productivity.

The block copolymer, if containing the first and second polymer segments distinguished in composition from each other by the difference in glass transition temperature therebetween, exhibits improved low temperature tackiness and cohesion force compared to conventional acrylic copolymers made via random copolymerization.

Preferably, a glass transition temperature of the first polymer segment is maintained not to fall below 30° C. so that it can impart the increased cohesive force to the block copolymer, and a glass transition temperature of the second polymer segment is maintained not to exceed 0° C. so that it can impart the enhanced tackiness to the block copolymer.

The type of the monomer used to constitute the polymer segments is not particularly specified, so long as it can undergo free-radical polymerization to produce a homopolymer or copolymer. Examples of monomers include (meth)acrylic acid; (meth)acrylates represented by alkyl (meth)acrylates containing 1-30 carbon atoms in the alkyl, hydoxyethyl (meth)acrylate, hydroxypropyl (meth)acrylate, 4-hydroxybutyl (meth)acrylate, glycidyl (meth)acrylate, methoxyethyl (meth)acrylate and ethoxyethyl (meth)acrylate; styrenic monomers represented by α-methylstyrene, vinyltoluene and styrene; vinyl ether monomers represented by methyl vinyl ether, ethyl vinyl ether and isobutyl vinyl ether; fumaric acid and its monoalkyl and dialkyl esters; maleic acid and its monoalkyl and dialkyl esters; itaconic acid and its monoalkyl and dialkyl esters and the like. Other applicable monomers include (meth)acrylonitrile, butadiene, isoprene, vinyl chloride, vinylidene chloride, vinyl acetate, vinyl ketone, vinyl pyridine, vinyl carbazole and the like. The above-listed monomers can be used alone or in combination.

Both or one of the first and second polymer segments incorporated in the block copoymer, for use in the acrylic hot melt pressure-sensitive adhesive in accordance with the present invention, is copolymerized with an olefinic macromer. The olefinic macromer, as used herein, is an olefinic polymer having at least one end modified with a free-radically polymerizable unsaturated double bond. The type of the olefinic macromer is not particularly specified, so long as it contains a double bond copolymerizable with other polymeric monomer. Preferably, its olefinic moiety comprises polyethylene, polypropylene, an ethylene-butylene copolymer or any combination thereof. The double bond copolymerizable with other polymeric monomer refers to a free-radically polymerizable unsaturated double bond. Examples of functional groups having such an unsaturated double bond include vinyl, (meth)acryloyl, allyl and the like.

The copolymerization of each block comprising the first or second polymer segment with the olefinic macromer can be achieved via polymerization of the olefinic macromer under the presence of at least one monomer useful for constituting the polymer segment.

Specific examples of olefinic macromers include Craton Liquid Polymer L-1253, manufactured by Shell Chemical Company, which is an ethylene-butylene copolymer modified at its terminal with methyl methacrylate ester; compounds made via terminal modification of polyethylene, polypropylene or an ethylene-butylene random copolymer with (meth)acrylate, such as methyl methacrylate ester, as disclosed in Japanese Patent Laying-Open No. Hei 8-169922 (1996); and the like.

### BASE FILM LAYER

In the fabrication of the protective film in accordance with the present invention, the acrylic hot melt pressure-sensitive adhesive layer in accordance with the present invention is applied to one surface of a base film layer. The material type of the base film layer is not particularly specified, so long as it has a fundamental strength enough to accomplish the pimary object of protecting adherends and also has sufficient flexibility to permit its removal.

Examples of materials used to form the base film layer include polyethylenes such as low-density polyethylene, medium-density polyethylene, high-density polyethylene and straight-chain low-density polyethylene; polypropylens such as blocked polypropylene, homopolypropylene and random polypropylene; plasticized vinyl chlorides; polyethylenes such as polyethylene terephthalate.

Particularly preferred base film layer materials are polyethylenes and polypropylenes. Although conventional acrylic pressure-sensitive adhesives often show insufficient adhesion to base film layers, the acrylic hot melt pressure-sensitive adhesive in accordance with the present invention exhibits good adhesion to base film layers even if composed of polyethylenes or polypropylenes. This permits suitable use of polyethylenes or polypropylenes for the base film layer. The good adhesion of the acrylic hot melt pressure-sensitive adhesive in accordance with the present invention relative to polyethylenes or polypropylenes is probably attributed to the presence of the copolymerized olefinic macromer.

### PROTECTIVE FILM

The protective film in accordance with the present invention is applied to reside on an adherend while its protection is needed and removed therefrom if its protection is no longer required. It is accordingly desired that the protective film exhibits an initial 180° peel adhesion to a stainless steel (SUS 304) sheet of not exceeding 4.903325 N/25 mm when measured according to JIS Z 0237.

It is therefore preferred that the protective film is constructed such that its initial peel adhesion does not exceed 4.903325 N/25 mm.

There are various techniques which may be utilized to prepare the protective film, including hot melt application of the acrylic hot melt pressure-sensitive adhesive in accordance with the present invention to one surface of the base film layer, and coextrusion of the base film material and the acrylic hot melt pressure-sensitive adhesive.

In the case where the hot melt application technique is utilized, the base film layer is preferably subjected to a treatment known in the art to enhance its adhesion to the hot melt pressure-sensitive adhesive, before the adhesive is applied thereto. For example, the base film layer may be at its surface subjected to corona discharge or coated with an anchoring agent.

### OPTIONAL COMPONENTS

A release agent can be incorporated in the pressure-sensitive adhesive of the present invention to enhance its removability. Examples of release agents include silicone compounds; perfluoro polymers; long chain alkyl-containing polymers such as polystearyl acrylate; a combination of a polymer with a long chain alkyl-containing compound, such as a mixture of stearamide and polyethylene; long chain alkyl-containing amide compounds such as ethylene-bis-stearamide, octadecylisocyanate adduct of polyethylene-imine; and the like.

Other than the above-specified block copolymer, various polymers can also be incorporated in the pressure-sensitive adhesive in accordance with the present invention within the range that does not adversely affect the purpose of the invention. Such polymers include, for example, a tackifying resin, filler, antioxidant, UV absorber.

When any of such polymers is used, its loading may be suitably selected within the range that does not hinder the purpose of the present invention. It should be however understood that if the present invention is to be effective, the above-specified block copolymer is contained preferably within the range of 50 100% by weight, more preferably within the range of 60-100% by weight, further preferably within the range of 70-100% by weight, further preferably within the range of 80-100% by weight, most preferably within the range of 90-100% by weight, based on 100% by weight of all the polymers incorporated in the pressure-sensitive adhesive.

The tackifying resin is not particularly specified in type. Examples of tackifying resins include C₅ petroleum resins, C₉ petroleum resins, rosin, rosin esters, terpene resins, terpene-phenol resins, coumarone-indene resins, disproportionated rosin esters, polymerized rosin resins, polymerized rosin ester resins and hydrogenated derivatives thereof. These tackifying resins may be used alone or in any combination.

Examples of fillers include, but not limited to, calcium carbonate, titanium oxide, mica, talc and the like.

Examples of antioxidants include, but not limited to, phenols such as monophenols, bisphenols and polyphenols; sulfur compounds and phosphites and the like.

Examples of UV absorbers include, but not limited to, salicylic acid derivatives, benzophenones, benzotriazoles, cyanoacrylates and the like.

Such components as an antioxidant, UV absorber, filler and pigment can also be added to the base film material, when needed.

Examples of antioxidants, UV absorbers and fillers are listed above.

Examples of pigments include, but not limited to, azo, phthalocyanine and so-called high performance pigments.

When necessary to reduce the tendency of the protective film to develop, a release agent may be applied to one side of the base film layer which carries the pressure-sensitive adhesive layer on its other side. Examples of release agents are listed above.

### DESCRIPTION OF THE PREFERRED EXAMPLES

The following non-limiting examples clearly illustrate the present invention.

### Preparation of Polymer P-1

A 1-liter, four-necked flask equipped with a “Max Blend” blade (product of Sumitomo Heavy Industries Ltd.), nitrogen line, dropping funnel, thermometer and cooling condenser was charged with 198 g of methyl methacrylate, 2 g of acrylic acid, 5.0 g of trimethylolpropane trimercaptopropionate, 200 g of ethyl acetate and 1.5 g of azobiscyclohexane carbonitrile. The flask content was allowed to polymerize at 82° C. under nitrogen atmosphere.

When the conversion reached 85%, a monomer mixture containing 514 g of butyl acrylate, 80 g of Craton Liquid L-1253 and 6 g of acrylic acid was added dropwise from the dropping funnel to further effect polymerization.

At the point when the conversion reached or exceeded 95%, termination of the polymerization was achieved by adding 0.08 g of 6-t-butyl-2,4-xylenol as a termination agent.

The resulting reaction mixture was transferred into a twin-screw extruder in which its volatiles were removed, and then extruded from a die having cylindrical cavities 5 mm in diameter into somewhat cloudy white, solid polymer strands.

The polymer produced was designated as P-1. This polymer P-1 had a somewhat cloudy white appearance and was determined to have a weight average molecular weight Mw=245,000, a number average molecular weight Mn=25,000, a molecular weight distribution (polydispersity) Mw/Mn=9.7 and glass transition temperatures Tg's=−45° C. and 94° C.

### Preparation of Polymer P-2

A 1-liter, four-necked flask equipped with a “Max Blend” blade (product of Sumitomo Heavy Industries Ltd.), nitrogen line, dropping funnel, thermometer and cooling condenser was charged with 198 g of methyl methacrylate, 2 g of acrylic acid, 5.0 g of trimethylolpropane trimercaptopropionate, 200 g of ethyl acetate and 1.5 g of azobiscyclohexane carbonitrile. The flask content was allowed to polymerize at 82° C. under nitrogen atmosphere.

When the conversion reached 85%, a monomer mixture containing 594 g of butyl acrylate and 6 g of acrylic acid was added dropwise from the dropping funnel to further effect polymerization.

At the point when the conversion reached or exceeded 95%, termination of the polymerization was achieved by adding 0.08 g of 6-t-butyl-2,4-xylenol as a termination agent.

The resulting reaction mixture was transferred into a twin-screw extruder in which its volatiles were removed, and then extruded from a die having cylindrical cavities 5 mm in diameter into clear fluorescent, solid polymer strands.

The polymer produced was designated as P-2. This polymer P-2 showed good transparency and was determined to have a weight average molecular weight Mw=206,000, a number average molecular weight Mn=38,000, a molecular weight distribution (polydispersity) Mw/Mn=5.5 and glass transition temperatures Tg's=−45° C. and 94° C.

### Preparation of Polymer P-3

A 1-liter, four-necked flask equipped with a “Max Blend” blade (product of Sumitomo Heavy Industries Ltd.), nitrogen line, dropping funnel, thermometer and cooling condenser was charged with 198 g of methyl methacrylate, 514 g of butyl acrylate, 80 g of Craton Liquid L-1253, 8 g of acrylic acid, 5.0 g of trimethylolpropane trimercaptopropionate, 800 g of ethyl acetate and 1.5 g of azobiscyclohexane carbonitrile. The flask content was allowed to polymerize at 82° C. under nitrogen atmosphere.

At the point when the conversion reached or exceeded 95%, termination of the polymerization was achieved by adding 0.08 g of 6-t-butyl-2,4-xylenol as a termination agent.

The resulting reaction mixture was transferred into a twin-screw extruder in which its volatiles were removed, and then extruded from a die having cylindrical cavities 5 mm in diameter into somewhat cloudy white, solid polymer strands.

The polymer produced was designated as P-3. This polymer P-3 was determined to have a weight average molecular weight Mw=210,000, a number average molecular weight Mn=40,000, resulting in a molecular weight distribution (polydispersity) Mw/Mn=5.3. The polymer exhibited a sole glass transition temperature Tg=−10° C. This is considered probably due to its random structure instead of a block structure.

### Preparation of Polymer P-4

A separable flask equipped with a stirrer, cooling condenser, thermometer and nitrogen line was charged with 198 g of methyl methacrylate, 514 g of butyl acrylate, 80 g of Craton Liquid L-1253, 8 g of acrylic acid and 800 g of toluene. The monomer mixture was bubbled with nitrogen gas for 20 minutes to remove oxygen dissolved therein. After the separable flask was purged with nitrogen gas, heating and stirring were initiated to elevate a temperature of the monomer mixture.

At the point when a condensed liquid appeared in the cooling condenser, polymerization at the boiling point was initiated by introducing 0.30 g of 1,1-di(t-hexaperoxy)-3,3,5-trimethylcyclohexane (PERHEXA TMH, name designated in trade and manufactured by NOF Corporation) dissolved in about 1 g ethyl acetate, as a polymerization initiator.

After the lapse of 1 hour, 0.60 g of PERHEXA TMH dissolved in about 1 g ethyl acetate was again introduced. Also, di(3,5,5-trimethylhexanoyl)peroxide (PEROYL 355, name used in trade and manufactured by NOF Corporation) was periodically introduced in the amount of 0.60 g, 1.20 g and 1.80 g, respectively dissolved in about 1 g ethyl acetate, after the passage of 2, 3 and 4 hours from the start of polymerization. The polymerization at the boiling point was continued for 8 hours.

The resulting reaction mixture was transferred into a twin-screw extruder in which its volatiles were removed, and then extruded from a die having cylindrical cavities 5 mm in diameter into somewhat cloudy white, solid polymer strands.

The polymer produced was designated as P-4. This polymer P-4 was determined to have a weight average molecular weight Mw=411,000, a number average molecular weight Mn=81,000, resulting in a molecular weight distribution (polydispersity) Mw/Mn=5.1. The polymer exhibited a sole glass transition temperature Tg=−10° C. The polymer is considered to have a random structure, as can also be predicted from the polymerization mechanism used.

### Fabrication of Protective Film

### EXAMPLE 1

A multilayer extruder incorporating No. 1-No.3 extruder units was utilized. A polyethylene resin (MIRASON 12, name used in trade and manufactured by Mitsui Chemicals Inc.) was introduced in the No. 1 and No. 2 extruder units through their respective hoppers. The strand-form polymer P-1 was introduced directly in the No. 3 extruder unit. Extrusion was performed at a temperature of 170° C. The multilayer extrusion resulted in the provision of a surface protection film A having a base film layer of polyethylene and an acrylic hot melt pressure-sensitive adhesive layer of the polymer P-1 provided on one surface of the base film layer. The surface protection film A was 60 μm thick, i.e., consisted of the 50 μm thick polyethylene base film layer and the 10 μm thick pressure-sensitive layer.

### EXAMPLE 2

A multilayer extruder incorporating No.1-No. 3 extruder units was utilized. A polyethylene resin (MIRASON 12, name used in trade and manufactured by Mitsui Chemicals Inc.) was introduced in the No.1 extruder unit through its hopper. An SEBS resin (CRATON G-1657, name used in trade and manufactured by Shell Chemical) was introduced in the No. 2 extruder unit through its hopper. The strand-form polymer P-1 was introduced directly in the No. 3 extruder unit. Extrusion was performed at a temperature of 170° C. The multilayer extrusion resulted in the provision of a surface protection film B having a base film layer made of polyethylene, an acrylic hot melt pressure-sensitive adhesive layer made of the polymer P-1 and an SEBS resin layer interposed between the above two layers. The surface protection film B measured an overall thickness of 70 μm, including the 50 μm thick polyethylene base film layer, the 10 μm thick pressure-sensitive layer and the 10 μm thick SEBS resin layer. For the surface protection film B, the interposition of the SEBS resin layer improves adherence of the pressure-sensitive adhesive layer to the base film layer.

### Comparative Example 1

The procedure of Example 1 was followed, except that the strand-form polymer P-2 was used instead of the polymer P-1, to obtain a surface protection film of Comparative Example 1.

### Comparative Example 2

The procedure of Example 1 was followed, except that the polymer was changed from P-1 to P-3, to obtain a surface protection film of Comparative Example 2.

### Comparative Example 3

The procedure of Example 1 was followed, except that the polymer was changed from P-1 to P-4, to obtain a surface protection film of Comparative Example 3.

### Comparative Example 4

Polyethylene (MIRASON 12, name designated in trade and manufactured by Mitsui Chemicals Inc.) was extruded into a 50 μm thick film. The volatile-containing reaction mixture obtained in the preparation of the polymer P-1 was applied to one surface of the 50 μm thick polyethylene film to a dry film thickness of 10 μm and dried in an oven at 80° C. to exclude the volatile therefrom. As a result, a protective film of Comparative Example 4 was obtained.

### EVALUATION

The following procedures were utilized to evaluate (1) low temperature tackiness, (2) initial peel adhesion to PE, (3) initial peel adhesion to SUS and (4) aged peel adhesion to SUS in accordance with JIS Z 0237.

### (1) Low Temperature Tackiness

Each protective film was adhered to a stainless steel (SUS 304) sheet at a surrounding temperature of 0° C., left adhered for a period of 20 minutes, and evaluated according to JIS Z 0237 for 180° peel adhesion as an indication of low temperature tackiness.

### (2) Initial Peel Adhesion to PE

Each protective film was adhered to a high-density polyethylene sheet at a surrounding temperature of 23° C., left adhered for a period of 20 minutes, and then evaluated according to JIS Z 0237 for 180° peel adhesion as a measure of its initial peel adhesion to PE.

### (3) Initial Peel Adhesion to SUS

Each protective film was adhered to a stainless steel (SUS 304) sheet at a surrounding temperature of 23° C., left adhered for a period of 20 minutes, and evaluated according to JIS Z 0237 for 180° peel adhesion as a measure of its initial peel adhesion to SUS.

### (4) Aged Peel Adhesion to SUS

Each protective film was adhered to a stainless steel (SUS 304) sheet at a surrounding temperature of 23° C., aged at 80° C. for a period of 1 week, and then measured according to JIS Z 0237 for 180° peel adhesion as a measure of its aged peel adhesion to SUS.

The results are given in the following Table 1.

TABLE 1

| | Low | | | |
|---|---|---|---|---|
| | Temperature | | | Aged Peel |
| | Peel | Peel Adhesion | Peel Adhesion | Adhesion To |
| | Adhesion | To PE | To SUS | SUS |
| Ex. 1 | 1.568N/ | 0.784N/25 mm | 1.735N/25 mm | 5.713N/25 mm |
| | 25 mm | | | |
| Ex. 2 | 1.853N/ | 0.845N/25 mm | 1.991N/25 mm | 5.806N/25 mm |
| | 25 mm | | | |
| Comp. | Adhesive | 0.833N/25 mm | Adhesive | Adhesive |
| Ex. 1 | Residue | | Residue | Residue |
| Comp. | 0.098N/ | 0.196N/25 mm | 1.215N/25 mm | 4.568N/25 mm |
| Ex. 2 | 25 mm | | | |
| Comp. | 0.098N/ | 0.666N/25 mm | 1.323N/25 mm | 4.763N/25 mm |
| Ex. 3 | 25 mm | | | |
| Comp. | 2.058N/ | 0.833N/25 mm | 1.882N/25 mm | Adhesive |
| Ex. 4 | 25 mm | | | Residue |

As can be seen from Table 1, the protective film obtained in Comparative Example 1 by using the polymer P-2 left a perceptive adhesive residue when it was removed in evaluating the low temperature tackiness, initial peel adhesion to SUS and aged peel adhesion. That is, it showed insufficient low-temperature releasability and removability from the high-polarity adherend.

The protective film obtained in Comparative Example 4 by using the solvent-based pressure-sensitive adhesive left an adhesive residue in the evaluation of aged peel adhesion to SUS.

Although left no adhesive residue in each peel adhesion evaluation test, the protective films respectively obtained in Comparative Examples 2 and 3 exhibited the low peel value of 0.098 N/25 mm in the evaluation test of low temperature tackiness, demonstrating insufficient adhesive performances of the polymers P-3 and P-4. The protective film obtained in Comparative Example 2 gave an extremely low value for peel adhesion to PE and its peel adhesion was varied largely upon the type of the adherend used.

By contrast, the protective films obtained in Examples 1 and 2 left no adhesive residue in either evaluation test, gave high peel values in the low temperature tackiness evaluation test and showed the reduced variations in peel adhesion with the type of the adherend used.

In addition to the above-described advantages, the acrylic hot melt pressure-sensitive adhesive in accordance with the present invention simplifies a manufacturing process, since it can be manufactured without the need to use a crosslinking agent and the like. The protective film in accordance with the present invention also simplifies a manufacturing process since it can be manufactured simply by hot melt applying the acrylic hot melt pressure-sensitive adhesive to a base film layer.

What is claimed is:

1. An acrylic hot melt pressure-sensitive adhesive containing a block copolymer comprising a polyvalent mercaptan core, first and second acrylic polymer segments different in composition from each other and radially extending from the mercaptan core, both or one of said first and second polymer segments being copolymerized with an olefinic macromonomer.

2. The pressure-sensitive adhesive of claim 1, wherein said olefinic macromonomer contains an olefinic moiety selected from the group consisting of an ethylene polymer, ethylene-butylene copolymer, ethylene-propylene copolymer and any mixture thereof.

3. The pressure-sensitive adhesive of claim 1, wherein said first polymer segment has a glass transition temperature of not below 35° C. and said second polymer segment has a glass transition temperature of not above 0° C.

4. The pressure-sensitive adhesive of claim 3, wherein said olefinic macromonomer contains an olefinic moiety selected from the group consisting of an ethylene polymer, ethylene-butylene copolymer, ethylene-propylene copolymer and any mixture thereof.

5. A protective film including:
a pressure-sensitive adhesive layer composed of an acrylic hot melt pressure-sensitive adhesive containing a block copolymer comprising a polyvalent mercaptan core, first and second acrylic polymer segments different in composition from each other and radially extending from the mercaptan core, both or one of said first and second polymer segments being copolymerized with an olefinic macromonomer; and
a base film layer carrying said adhesive layer on its one surface;
said protective film having an initial 180° peel adhesion to a stainless steel sheet of not exceeding 4.903325 N/25 mm when measured at 23° C. according to JIS Z 0237.

6. The protective film of claim 5, wherein said base film layer is composed of polyethylene or polypropylene.

7. The protective film of claim 5, wherein said olefinic macromonomer contains an olefinic moiety selected from the group consisting of an ethylene polymer, ethylene-butylene copolymer, ethylene-propylene copolymer and any mixture thereof.

8. The protective film of claim 7, wherein said base film layer is composed of polyethylene or polypropylene.

9. The protective film of claim 5, wherein said first polymer segment has a glass transition temperature of not below 35° C. and said second polymer segment has a glass transition temperature of not above 0° C.

10. The protective film of claim 9, wherein said olefinic macromonomer contains an olefinic moiety selected from the group consisting of an ethylene polymer, ethylene-butylene copolymer, ethylene-propylene copolymer and any mixture thereof.

11. The protective film of claim 10, wherein said base film layer is composed of polyethylene or polypropylene.
